(19) United States
(12) Patent Application Publication
(10) Pub. No.: US 2022/0269107 A1
(43) Pub. Date: Aug. 25, 2022

(54) CONFIGURABLE OPTICAL STRUCTURES

(71) Applicant: Arris Composites Inc., Berkeley, CA (US)

(72) Inventors: Sam PIRAHANCHI, Novato, CA (US); Erick DAVIDSON, Piedmont, CA (US); J. Scott PERKINS, Oakland, CA (US); Simon LANCASTER-LAROCQUE, San Jose, CA (US); Ethan ESCOWITZ, Berkeley, CA (US); Riley REESE, Oakland, CA (US)

(21) Appl. No.: 17/677,754

(22) Filed: Feb. 22, 2022

Related U.S. Application Data
(60) Provisional application No. 63/152,247, filed on Feb. 22, 2021.

(51) Int. Cl. G02C 5/14

(52) U.S. Cl. CPC G02C 5/146; G02C 2200/08

(57) ABSTRACT

An eyewear frame enables lenses and/or temples to be replaced by a wearer without specialized tools and without the assistance of an eyewear professional. The eyewear frame includes one or more regions having distinct materials composition and/or one or more regions having distinct fiber alignment, in conjunction with one or more lens or temple retaining features.

### STATEMENT OF RELATED CASES

This disclosure claims priority of U.S. Pat. App. Ser. No. 63/152,247, filed Feb. 22, 2021.

### FIELD OF THE INVENTION

The present invention pertains to fiber-composite materials, and products made from fiber-composite materials.

### BACKGROUND OF THE INVENTION

Consumers value eyewear products that are inexpensive as well as unique. The challenge for manufacturers is that these two criteria—cost and product differentiation—are often at odds with one another. To wit, discount-store sunglasses are cheap but bland, whereas luxury brands are distinctive but expensive.

An aspect of product differentiation for consumers is ease of re-configurability, primarily for eyewear lenses. A desirable product would enable users to swap lenses on their own, without risk of damage or the need for a retailer's help. Of additional consumer interest is having an ability to swap the eyewear “temples” (i.e., the earpieces that rest against a wearer's ears/head to keep the frame in place).

This differentiation presents a challenge for manufacturers. Functional eyewear must ensure that the lenses remain in place during use. Moreover, as the complexity of an eyewear frame increases, lens insertion during manufacturing becomes increasingly difficult, and hence more expensive. An ideal eyewear frame would therefore facilitate a lens insertion method that: i) can be performed by consumers, ii) is robust enough to keep the lenses in the frame under all likely use scenarios, and iii) can be performed cost effectively during manufacture in high production volumes.

Prior-art eyewear offers a range of compromises between these three criteria. In less expensive products, lenses are often fixed and cannot be replaced. Products with replaceable lenses often require intervention by a retailer using custom tools. Those products that do enable lens reconfigurability by the user often suffer from inadvertent lens pop-out during use. And the cost of lens insertion during manufacture is a constraint in all cases.

Although the temples do not present as complex an assembly problem as lenses for manufacturers, they must be similarly robust during use yet easily configured by users to achieve viable product differentiation. As such, they are subject to the same three criteria.

In some embodiments, the invention provides an eyewear frame having: a first rim and a second rim, each rim shaped to receive an eyewear lens, each rim having an outwardly facing surface and an inwardly facing surface, the first and second rims comprising a first thermoplastic resin; a first lens-retaining feature depending from a medial side of the first and second rims and a second lens-retaining feature depending from a lateral side of the first and second rims, wherein: (a) the first and second lens-retaining features are proximal to the outwardly facing surface of respective first and second rims, (b) the first and second lens retaining features of respective first and second rims extend inwardly towards one another, (c) the first and second lens-retaining features comprise a second thermoplastic resin, (d) the second thermoplastic resin is relatively more compliant than the first thermoplastic resin; and a third lens-retaining feature depending from the inwardly facing surface of the rim.

In some embodiments, the invention provides a method for making an eyewear frame, the method compromising: providing an assemblage of preforms, the assemblage including a plurality of fiber-bundle-based preforms, wherein the fiber-bundle-based preforms are arranged into a shape of the eyewear frame, the shape comprising: (a) a first rim and a second rim, each rim having a closed geometry and configured to receive an eyewear lens, (b) a first lens-retaining feature depending from a medial side of the first and second rims and a second lens-retaining feature depending from a lateral side of the first and second rims, the first and second lens-retaining feature depending from a first surface of each rim, (c) a third lens-retaining feature sited proximal to the lateral side of the first and second rims and depending from a second surface of each rim, and wherein the assemblage includes at least one of: one or more distinct material regions and one or more distinct fiber alignment regions, wherein: (i) each distinct material region comprises a first thermoplastic polymer that is relatively more compliant than a second thermoplastic resin disposed in regions of the assemblage other the one or more distinct material regions; and (ii) each distinct fiber-alignment region is a region in which a fiber orientation differs from other regions within the assemblage; and compression molding the assemblage to provide an eyewear frame.

### SUMMARY OF THE INVENTION

Embodiments of the invention avoid some of the costs and disadvantages of the prior art. The illustrative embodiment of the invention is an eyewear frame that:
enables lenses and temples to be readily removed and replaced with other versions,
provides robust component retainment during use, and
is formed via an inexpensive integrated manufacturing process.

The exchange and retainment capability of a frame formed in accordance with the present teachings is facilitated by creating, in the frame, (a) one or more regions having distinct materials composition and/or one or more regions having distinct fiber alignment, in conjunction with (b) one or more lens and/or temple retaining features.

The ability to create such distinct materials and fiber-alignment regions is provided through the use of applicant's unique compression-molding processes. Appropriately designed and placed, these regions reduce the risk of a lens or temple inadvertently dislodging relative to prior art eyewear frames. The ability to retain the lenses and temples is achieved via the same approach, albeit the distinct materials and fiber-alignment regions are at different locations on the frame.

Although eyewear frames having an identical geometry may possibly be produced via alternative methods, such as injection molding, such frames would not function adequately (e.g., the lenses are likely to pop-out during use, etc.). The functionality possessed by the illustrative embodiment results from, among other considerations, the unique ability of applicant's manufacturing methods to create, with high specificity, regions of desired fiber alignment and/or materials composition within an eyewear frame.

Embodiments of the present invention also provide distinct material regions that contribute to aesthetics and wearability, such as soft-touch temples for improved grip. These additional material aspects do not interfere with the manufacturing or functional requirements of lens or temple reconfigurability.

### BRIEF DESCRIPTION OF THE DRAWINGS

FIG. 1A depicts a perspective view of the outward-facing surface of a portion of an eyewear frame in accordance with an illustrative embodiment of the invention.

FIG. 1B depicts a perspective view of the inward-facing surface of the portion of the eyewear frame of FIG. 1A.

FIG. 1C depicts distinct material regions and distinct fiber alignment regions of the portion of the eyewear frame of FIG. 1A.

FIG. 1D depicts the manner in which force is applied to the eyewear frame of FIG. 1A to remove or insert a lens.

FIG. 2 depicts a first embodiment of a temple-retaining feature of an eyewear frame in accordance with the present teachings.

FIG. 3 depicts a second embodiment of a temple-retaining feature of an eyewear frame in accordance with the present teachings.

FIG. 4A through 4D depict a variety of distinct material and fiber-alignment regions in an eyewear frame in accordance with the present teachings.

### DETAILED DESCRIPTION

The following terms, and their inflected forms, are defined for use in this disclosure and the appended claims as follows:
“Fiber” means an individual strand of material. A fiber has a length that is much greater than its diameter. A fiber may be classified as being “continuous.” Continuous fibers have a length that is no less than about 60 percent of the length of a mold feature or part feature where they will ultimately reside. Hence, the descriptor “continuous” pertains to the relationship between the length of a fiber and a length of a region in a mold or part in which the fiber is to be sited. For example, if the long axis of a mold has a length of 100 millimeters (mm), fibers having a length of about 60 mm or more would be considered “continuous fibers” for that mold. A fiber having a length of 20 mm, if intended to reside along the same long axis of the mold, would not be “continuous.” Such fibers are referred to herein as “short fibers.” Short fiber, as the term is used herein, is distinct from “chopped fiber,” as that term is typically used in the art. In the context of the present disclosure, all fibers, regardless of length, will be sourced from preforms. And substantially all of the (typically thousands of) fibers in a preform are unidirectionally aligned. As such, all fibers, regardless of length and regardless of characterization as “continuous” or otherwise, will have a defined orientation in the preform layup or preform charge in the mold and in the final part. Chopped fiber, as that term is used in the art, refers to fibers that, in addition to being short, has a random orientation in a mold and the final part.
“Fiber bundle” means plural (typically multiples of one thousand) co-aligned fibers.
“Tow” means a bundle of unidirectional fibers, (“fiber bundle” and “tow” are used interchangeably herein unless otherwise specified). Tows are typically available with fibers numbering in the thousands: a 1K tow (1000 fibers), 4K tow (4000 fibers), 8K tow (8000 fibers), etc.
“Prepreg” means fibers, in any form (e.g., tow, woven fabric, tape, etc.), which are impregnated with resin.
“Towpreg” or “Prepreg Tow” means a fiber bundle (i.e., a tow) that is impregnated with resin.
“Preform” means a segment of plural, co-aligned, resin-impregnated, typically same-length fibers. The segment is cut to a specific length, and, in many cases, will be shaped (e.g., bent, twisted, etc.) to a specific form, as appropriate for the specific part being molded. Preforms are usually sourced from towpreg (i.e., the towpreg is sectioned to a desired length), but can also be from another source of plural co-aligned, unidirectionally aligned fibers (e.g., from a resin impregnation process, etc.). The cross section of the preform, and the fiber bundle from which it is sourced, typically has an aspect ratio (width-to-thickness) of between about 0.25 to about 6, and most typically about 1 to 2. Preforms typically, but not necessarily, have a circular or oval cross section. Nearly all fibers in a given preform have the same length (i.e., the length of the preform) and, as previously noted, are co-aligned. The modifier “fiber-bundle-based” or “aligned-fiber” is often pre-pended, herein, to the word “preform” to emphasize the nature of applicant's preforms and to distinguish them from prior-art preforms, which are typically in the form of tape, sheets, or shapes cut from sheets of fiber. Applicant's use of the term “preform” explicitly excludes any size of shaped pieces of: (i) tape (typically having an aspect ratio, as defined above, of between about 10 to about 30), (ii) sheets of fiber, and (iii) laminates. Regardless of their ultimate shape/configuration, these prior-art versions of preforms do not provide an ability to control fiber alignment in a part in the manner of applicant's fiber-bundle-based preforms.
“Consolidation” means, in the molding/forming arts, that in a grouping of fibers/resin, void space is removed to the extent possible and as is acceptable for a final part. This usually requires significantly elevated pressure, either through the use of gas pressurization (or vacuum), or the mechanical application of force (e.g., rollers, etc.), and elevated temperature (to soften/melt the resin).
“Partial consolidation” means, in the molding/forming arts, that in a grouping of fibers/resin, void space is not removed to the extent required for a final part. As an approximation, one to two orders of magnitude more pressure is required for full consolidation versus partial consolidation. As a further very rough generalization, to consolidate fiber composite material to about 80 percent of full consolidation requires only 20 percent of the pressure required to obtain full consolidation.
“Preform Charge” means an assemblage of (fiber-bundle-based/aligned fiber) preforms that are at least loosely bound together (“tacked”) so as to maintain their position relative to one another. Preform charges can contain a minor amount of fiber in form factors other than fiber bundles, and can contain various inserts, passive or active. As compared to a final part, in which fibers/resin are fully consolidated, in a preform charge, the hybrid/preforms are only partially consolidated (lacking sufficient pressure and possibly even sufficient temperature for full consolidation). By way of example, whereas a compression-molding process is typically conducted at about 1000-3000 psi (which will typically be the destination for a preform charge in accordance with the present teachings), the downward pressure applied to the preforms to create a preform charge in accordance with the present teachings is typically in the range of about 10 psi to a few hundred psi. Thus, voids remain in a preform charge, and, as such, the preform charge cannot be used as a finished part.
“Preform Layup” means an arrangement of individual preforms that is formed by placing preforms, one-by-one, into a mold cavity. A preform layup is distinguished from a preform charge, wherein for the latter, the preforms are at least loosely bound to one another and the assemblage thereof is usually formed outside of the mold cavity.
“Compatible” means, when used to refer to two different resin materials, that the two resins will mix and bond with one another.
“Compression molding” is a molding process that involves the application of heat and pressure to feed constituents for a period of time. The mold constituents are typically placed in a female mold half having a mold cavity. As the requisite amount of feed constituents are placed in the female mold half, a second mold half—a male mold half—is joined to the female mold half to close the mold cavity. The male mold half usually includes features that extend into the female male half to engage the feed constituents therein. For applicant's processes, the applied pressure is usually in the range of about 500 psi to about 3000 psi, and temperature, which is a function of the particular resin being used, is typically in the range of about 150° C. to about 400° C. Once the applied heat has increased the temperature of the resin above its melt temperature, it is no longer solid and will flow. The resin will then conform to the mold geometry via the applied pressure, and the feed constituents are thereby consolidated, resulting in very little void space. Elevated pressure and temperature are typically maintained for a few minutes. After this compression molding protocol is complete, the mold is removed from the source of pressure and is cooled. Once cooled, a finished part is removed from the mold.
“Stiffness” means resistance to bending, as measured by Young's modulus.
“Tensile strength” means the maximum stress that a material can withstand while it is being stretched/pulled before “necking” or otherwise failing (in the case of brittle materials).
“About” or “Substantially” means+/−20% with respect to a stated figure or nominal value.

Introduction. Existing eyewear frames are composed primarily of isotropic materials (i.e., materials in which physical properties have the same value when measured in different directions) In most cases, those materials are metal or plastic. These materials necessarily limit the differential force response of such frames to the geometry of the frame, alone. More particularly, if a designer wishes to have a conventional eyewear frame deflect more in bending along a specific axis, the only means to achieve this is to specify a particular geometry. However, style and form factor are primary motivators for consumer choice in eyewear; frame geometry is driven mainly by aesthetics, not functionality.

This inability, in the prior art, to decouple aesthetic design from functional design creates certain problems for the eyewear designer. In particular, this limits the ability of a designer to provide aesthetically desirable eyewear that is readily user reconfigurable, particularly with regard to lenses. Specifically, lenses that are easily swapped when the user applies a force, can also inadvertently dislodge during use via a similar but unintended force application. Conversely, lenses having complex insertion methods are robustly retained, but cannot be reconfigured by the user. In such cases, a trip to the retailer is required, wherein specific fixtures and/or tools are used by eyewear professionals to change lenses. Furthermore, such complex insertion methods contribute to manufacturing costs of the eyewear, as lens integration becomes a costly process at high production volumes.

Temples (i.e., earpieces) are also subject to reconfigurability constraints resulting from their attachment to frames. To keep temples robustly attached to frames, manufacturers typically use very small screws that also act as the pivot point for the temples to fold onto the frame. To prevent the repeated folding and unfolding of the temples from loosening those screws, conventional eyewear frames include specialized threads that keep the screws secure. Thus, the screws are not intended for frequent removal/insertion; as a result, the temples are not readily removable. In addition, such screws require uncommon screwdriver sizes. Enabling the user to reconfigure temples without degrading the frame, such as may occur via repeated screw removal, would increase style, fit, and functional latitudes.

An eyewear frame in accordance with the present teaching relaxes the geometry-or-aesthetics constraint of the prior art. In accordance with an illustrative embodiment, regions of an eyewear frame are provided with distinct materials and/or distinct fiber alignment (“distinct” relative to other regions of the frame) thereby enabling a differential response to applied forces. In combination with retaining features, the material/fiber-alignment induced differential response of the inventive eyewear frame enables lenses and temples to be reconfigured by the user via a specific application of force that does not occur during use. This avoids the problem of inadvertent dislodging that plagues the prior art. By specifying distinct regions of material and/or fiber alignment (i.e., tailoring compliance and stiffness), a specific action and/or simple tool can be used by the user to swap lenses and temples, as well as by the manufacturer to efficiently insert the relevant components during production.

Feed Constituents. In accordance with the present teachings, an eyewear frame in accordance with the present teachings is fabricated from fiber-composite feed constituents via a compression molding process. A mold cavity having a geometry and shape suitable for forming an eyewear frame is filled with an assemblage of such feed constituents. After the mold cavity (i.e., a female mold half) is mated to a male mold half, the mold is closed and subjected to elevated temperature and pressure in accordance with compression molding protocols. After a short dwell at temperature and pressure, pressure is released and the mold is cooled. A finished eyewear frame is then removed from the mold.

Unlike the prior art, applicant's compression molding processes utilize fiber-bundle-based preforms as the basic feed constituent. Each such preform is a segment of plural, co-aligned, same length, resin-impregnated fibers. Applicant uses such fiber-bundle-based preforms, to the extent possible, since they provide an unprecedented ability to align fibers in a finished part as desired. As discussed further below, this ability is particularly important for embodiments of the invention.

Each preform, like the spool of towpreg or the impregnation-line output from which it is sourced, include thousands of co-aligned, resin-infused fibers, typically in multiples of one thousand (e.g., 1k, 10k, 24k, etc.). A preform may have any suitable cross-sectional shape (e.g., circular, oval, trilobal, polygonal, etc.), although circular/oval geometries are most common.

The individual fibers in the fiber bundles can have any diameter, which is typically, but not necessarily, in a range of 1 to 100 microns. Individual fibers can include an exterior coating such as, without limitation, sizing, to facilitate processing, adhesion of binder, minimize self-adhesion of fibers, or impart certain characteristics (e.g., electrical conductivity, etc.).

Each individual fiber can be formed of a single material or multiple materials (such as from the materials listed below), or can itself be a composite. For example, an individual fiber can comprise a core (of a first material) that is coated with a second material, such as an electrically conductive material, an electrically insulating material, a thermally conductive material, or a thermally insulating material.

In terms of composition, each individual fiber can be, for example and without limitation, carbon, glass, natural fibers, aramid, boron, metal, ceramic, polymer filaments, and others. Non-limiting examples of metal fibers include steel, titanium, tungsten, aluminum, gold, silver, alloys of any of the foregoing, and shape-memory alloys. “Ceramic” refers to all inorganic and non-metallic materials. Non-limiting examples of ceramic fiber include glass (e.g., S-glass, E-glass, AR-glass, etc.), quartz, metal oxide (e.g., alumina), aluminasilicate, calcium silicate, rock wool, boron nitride, silicon carbide, and combinations of any of the foregoing. Furthermore, carbon nanotubes can be used.

Any thermoplastic resin that bonds to itself under heat and/or pressure can be used. Exemplary thermoplastic resins useful in conjunction with embodiments of the invention include, without limitation, acrylonitrile butadiene styrene (ABS), nylon, polyaryletherketones (PAEK), polybutylene terephthalate (PBT), polycarbonates (PC), and polycarbonate-ABS (PC-ABS), polyetheretherketone (PEEK), polyetherimide (PEI), polyether sulfones (PES), polyethylene (PE), polyethylene terephthalate (PET), polyphenylene sulfide (PPS), polyphenylsulfone (PPSU), polyphosphoric acid (PPA), polypropylene (PP), polysulfone (PSU), polyurethane (PU), polyvinyl chloride (PVC).

In preparation for molding a fiber-composite eyewear frame in accordance with the invention, preforms may be added one-by-one to a mold cavity, forming a “lay-up.” For a variety of reasons—most notably for both process efficiency as well a substantially greater likelihood that the desired preform alignment is maintained—in some embodiments, the preforms are grouped and tacked together prior to placement in a mold, and then placed in the mold cavity en masse. This grouping of preforms is referred to herein as a “preform charge.”

The preform charge is typically a three-dimensional arrangement of preforms, which is usually created in a fixture separate from the mold, and which is dedicated and specifically designed for that purpose. To create a preform charge, preforms are placed (either automatically or by hand) in a preform-charge fixture. By virtue of the configuration of the fixture, the preforms are organized into a specific geometry and then bound together, such as via heating and minimal applied pressure. The shape of the preform charge usually mirrors that of the intended part, or a portion of it, and, hence, the mold cavity (or at least a portion thereof) that forms the part. See, e.g., Publ. Pat. Apps US2020/0114596 and US2020/0361122, incorporated herein by reference.

As compared to a final part in which fibers/resin are fully consolidated, in a preform charge, the preforms are only partially consolidated. This is because there is insufficient pressure, and possibly even insufficient temperature for full consolidation. By way of example, whereas applicant's compression-molding processes are often conducted at a pressure of thousands of psi, the downward pressure applied to the constituents to create a preform charge in accordance with the present teachings is typically in the range of about 10 psi to a few hundred psi. Thus, voids remain in a preform charge, and, as such, the preform charge cannot be used as a finished part.

Although only partially consolidated, the preforms in the preform charge will not move, thereby maintaining the desired geometry and the specific alignment of each preform in the assemblage. This is important for creating a desired fiber alignment in the mold, and, hence, in the final part.

For use in conjunction with embodiments of the present invention, preforms may be organized as a “layup,” a “preform charge,” or both, as suits the particular embodiment. As used herein, the term “assemblage of feed constituents” (or “assemblage of preforms”) refers to either a lay-up of the feed constituents (or preforms), or a preform charge.

As previously noted, in accordance with an illustrative embodiment, regions of an eyewear frame are provided with distinct materials and/or distinct fiber alignment (“distinct” relative to the rest of the frame) thereby enabling a differential response to applied forces. In combination with retaining features, the material/fiber-alignment-induced differential response of the inventive eyewear frame enables lenses and temples to be reconfigured by the user via a specific application of force that does not occur during use.

Distinct material regions. Distinct material regions are defined as those having different thermoplastic resin (hereinafter “differential matrix polymer”) than the bulk of the eyewear frame. Consequently, the distinct material region(s) will exhibit one or more different properties than that of the bulk of the eyewear frame. Non-limiting examples of differential matrix polymers include thermoplastic polyurethane (TPU), polycarbonate (PC), and polymer blends, such as PC and acrylonitrile butadiene styrene (ABS), PC and other polymers, or blends of other polymers. The matrix polymer present in the bulk of the eyewear frame is typically PC or nylon.

In some embodiments, the differential matrix polymer will be relatively more compliant than the resin used in the bulk of the eyewear frame (i.e., the bulk matrix polymer). By purposefully positioning such differential matrix polymers in regions of the eyewear frame, differential compliance can be implemented. This permits lens and temple removal and insertion only under a specifically located and directed application of force—one that would rarely if ever occur during conventional use. Such regions need not (but may) occupy the entire frame cross section at a given location. Combined with underlying continuous fibers at variable volumetric ratios, a tuned response can be achieved in an arbitrary geometry. Most importantly, that geometry can be selected for aesthetic purposes.

In some embodiments, polycarbonate (PC) is used as the bulk matrix polymer as well as the differential matrix polymer. In such embodiments, to create the differential response of an eyewear frame, several scenarios are possible. For example, in some of such embodiments, the PC as the differential matrix polymer is neat (i.e., no fibers present), whereas the PC as the bulk matrix polymer includes fibers. Alternatively, fiber can be used in both for both bulk and differential matrix polymers, but the fiber volume fraction is varied as desired, to create a difference in stiffness between the distinct material region and the bulk region. In still further embodiments, whereas aligned fibers are present in the PC present throughout much of the frame, chopped (short, non-aligned) fiber is used in the distinct material region. In some other of such embodiments, the PC used for the differential matrix polymer and the bulk matrix polymer will differ in terms of the presence (or absence) of additives, or differ in terms of polymer blends.

Although the differential matrix polymer is typically present in the assemblage as a preform, it may have another suitable form factor, particularly if the differential matrix polymer is neat (no fibers). For example, in embodiments, it may be in the form of a block, pellets, etc. The differential matrix polymer can be present in multiple locations in the assemblage, as appropriate (e.g., several locations in support of lens reconfigurability, and/or several locations in support of temple reconfigurability, etc.). Moreover, different differential matrix polymers can be used in different locations.

Most polymers form incompatible, immiscible blends with each other. This means they remain chemically distinct, and the resulting heterogeneous blend has two glass-transition temperatures. Compatible, immiscible blends, which result from strong ionic or van der Waals forces between the polymers, create a polymer blend that is macroscopically uniform. Miscible polymers, such as (a) polyphenylene oxide (PPO) and polystyrene (PS), or (b) polyethylene terephthalate (PET) and polybutylene terephthalate (PBT), blend with each other to create a single-phase structure with only one glass-transition temperature.

The bulk matrix polymer and the differential matrix polymer(s) used in the conjunction with the embodiments of the invention can be miscible blends or compatible immiscible blends. Compatible immiscible blends and miscible blends will create near homogeneous structures in embodiments in which sufficient melt flow is achieved between the polymers.

It is notable that the melt temperature of the bulk matrix polymer and the (one or more) differential matrix polymers have “overlapping” melt-temperature profiles. In this context, that means that one of polymers will not combust, off-gas, or otherwise degrade before the other melts, lest a suboptimal part results. Most commercial polymers have a large melt-temperature range, thereby providing the requisite overlap and enabling use of many different combinations of polymers.

Distinct fiber-alignment regions. Fiber-alignment regions are those having distinct variance in fiber orientation across a defined boundary. The principles of anisotropy dictate a resultant differential stiffness in an eyewear frame due to this variance. For example, continuous fibers aligned to principal stress vectors can occupy a given region for stiffness to keep lenses in place during use. An adjacent but distinct region subject to minimal stress during use can include discontinuous, randomized fibers for a local reduction in stiffness (i.e., increased compliance). Applying force to this (relatively less stiff) region can cause the frame to flex as necessary to remove a lens, for example.

Distinct material regions and distinct fiber-alignment regions are not mutually exclusive; in some embodiments, they are both used, but in different regions of the eyewear frame. In some further embodiments, they are used together in the same region of an eyewear frame. That is, in some embodiments, a particular region will have both a differential matrix polymer, as well as a particular fiber alignment that is specific for the distinct region. Thus, such a region is both a distinct material region and a distinct fiber-alignment region.

In some embodiments, an eyewear frame will include only one or more distinct material regions, but no distinct fiber-alignment regions. In some other embodiments, an eyewear frame will include only one or more distinct fiber-alignment regions, but no distinct material regions.

Retaining features. Unlike conventional eyewear frames, a lens-retaining feature of eyewear in accordance with the present teachings is not a channel within the rim that surrounds each lens (because that is very difficult to achieve via a compression molding process). Rather, the lens-retaining features of embodiments of the invention are small protrusions, etc., which physically restrain a lens from moving once coupled to the eyewear frame. In some embodiments, to meet requirements, a lens-retaining feature itself will comprise a differential matrix polymer and/or a distinct fiber alignment. In some other embodiments, retaining features will incorporate neither a differential matrix polymer nor a distinct fiber alignment.

Both the retaining features and the region(s) of distinct materials and/or fiber alignment are required in order for eyewear frames in accordance with the invention to function adequately (i.e., retain lenses and temples during use, while also enabling them to be easily swapped by users). Without the differential response resulting from such regions, such functioning is not possible.

In some other embodiments, the frame itself can function as a lens-retaining feature. In particular, by having an open frame (i.e., one that does not form a closed loop), a distinct region of increased compliance can act as a living hinge. The frame will pivot at the living hinge under only specific conditions, thereby opening to enable a lens to be inserted/removed as desired by the user or manufacturer. In some further embodiments, opposing tabs and living-hinge frames can both be present in certain embodiments of eyewear frames.

Whereas lens-retaining features generally manifest in the rim surrounding the site of each lens, temple-retaining features are located at the desired pivot region on the frame that enables the temple to fold. They are likewise subject to compression-molding constraints, as well as specific force-application functionality.

In some embodiments, the temple-retaining feature may be a spring, implemented as paired cantilevered members that interlock the temple via a pivot feature disposed at an end of the temple (e.g., ball bearing, hemispherical protrusion, etc.). The temple-retaining feature can include distinct fiber alignment and/or a distinct material (i.e., differential matrix polymer) for desired stiffness and deflection. By tuning the response of the spring, the temple will release only when the spring deflects under the specific application of force.

The specific application of force to eyewear frames for lens and temple configuration is dependent on the distinct material regions and distinct fiber-alignment regions and retaining feature(s) of a given embodiment. Across all implementations, the specific application of force (required for insertion/removal) is not expected to occur during likely use scenarios. The frames therefore retain lenses and temples during use, wherein the components are inserted or released only when desired. Furthermore, the method of force application to configure components can be performed by users without special fixtures or custom tools (fingers and perhaps a coin are adequate), and performed by manufacturers cost effectively at scale.

By enabling lenses and temples to be configured via an operation that is simple yet specific, assembly of these components to corresponding eyewear frames is well suited to automation. In some embodiments, subtle indexing features on the eyewear frames may facilitate a configuring operation for manufacturers and users alike. For example, in some embodiments, a shallow channel registers eyewear frames onto a fixture during initial assembly, while also designating a grasp point for future user re-configurations. In some other embodiments, eyewear frames possess small gaps for “tool” access (e.g., a two-millimeter gap at a specific edge for a coin to act as a lever). Such gaps can also facilitate registration during automated assembly.

To insert/remove lenses in a given embodiment, the specific application of force can manifest as frame bending, torsion, strain deflection, or combinations thereof. In all embodiments, the relevant force is applied in a particular manner and along a specific axis. The point of bending, twisting, or expansion is determined by the relevant region(s) of differential compliance, as implemented via the use of distinctive materials and/or fiber-alignment. Use of a simple tool (e.g., coin, lever, etc.) to apply force may be necessary in some but not all embodiments. Temple insertion/removal is accomplished by the same principles, but occurring at or near the temple hinge.

A composite material having aligned fibers is more compliant than a composite material having chopped fibers (such as used in injection molding) when the torsional rotational axis is aligned with the aligned fibers. In some embodiments, this property of torsional compliance can be used to insert and remove a lens. A composite eyewear frame with fibers oriented in the hoop direction around a lens will have very high hoop stiffness for keeping a lens in place but low stiffness in torsion allowing the easy removal of lenses by twisting.

Special surfaces. In addition to providing distinct material regions for a specific force-response function, some embodiments of the present invention provide material surfaces for purposes of wearability and/or aesthetics. For example, in some embodiments, the eyewear frame includes “soft-touch” surfaces having increased grip for a secure fit, in addition to a crisp surface transition for cosmetics. Soft-touch material surfaces are less than two millimeters thick, and have continuous fibers beneath.

Distinct material surfaces are achieved through features of the compression mold, which primarily act to create a defined material transition on cosmetic surfaces. Such features include a thin “knife edge” to divide dissimilar material during molding, registration features to mold divisive inserts (e.g., a metal hoop, etc.) into the part, flow channels to divert converging flow fronts into flash, and molding methods developed by applicant that utilize multiple molding actions as a way to create layers of material in a single part, in a single compression-molding cycle (see, e.g., U.S. patent application Ser. No. 17/532,459 filed Nov. 22, 2021). Additionally, the mold surface can be coated with resin powder along appropriate surfaces to transfer onto the part during the molding process.

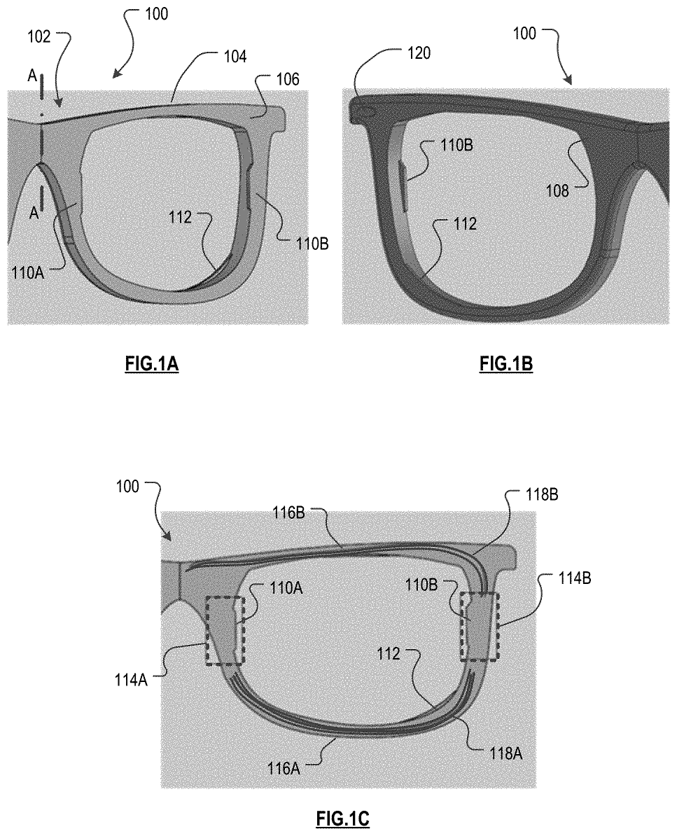

FIGS. 1A through 1B depict portion 102 of illustrative eyewear frame 100 in accordance with the present teachings. Portion 102 includes rim 104, which ultimately surrounds one of the two lenses that would be used in conjunction with eyewear frame 100. The eyewear frame is bilaterally symmetric about vertical centerline A-A.

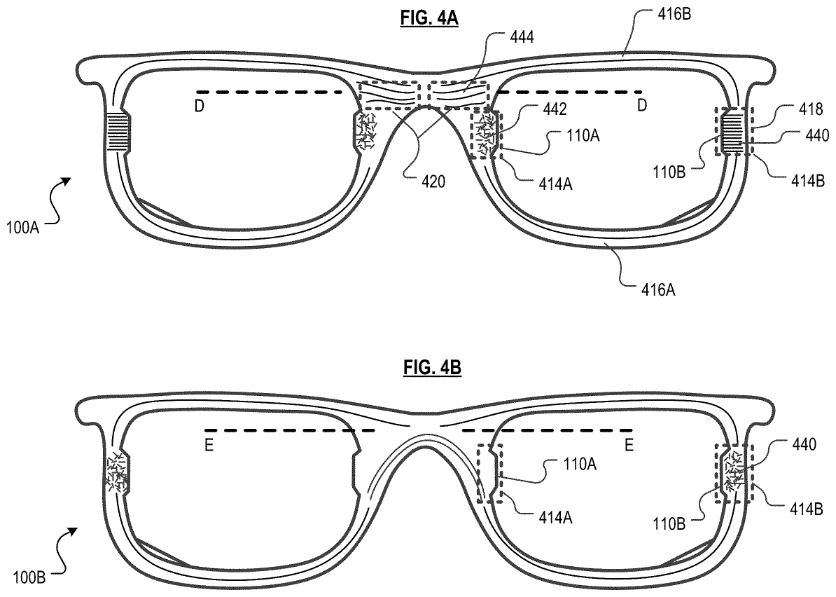

FIG. 1A depicts a perspective view showing outward-facing surface 106 of rim 104, and FIG. 1B depicts a perspective view showing inward-facing (wearer-facing) surface 108 of rim 104. For clarity, the temple hinge, which couples rim 104 to an associated temple at location 120, is not depicted in these Figures (see, FIG. 3).

Rim 104 includes lens-retaining features 110A, 110B, and 112. In the embodiment depicted in FIGS. 1A and 1B, lens-retaining features 110A and 110B are configured as protrusions or tabs that are situated on rim 104. Lens-retaining feature 110A is situated on the medial portion of rim 104, and lens-retaining feature 110B is situated on the lateral portion of rim 104. These lens-retaining features extend radially inward from rim 104, towards one another, more or less in-plane with outward-facing surface 106. (In this context, “radially inward” means towards the interior of region bounded by rim 104.)

In the illustrative embodiment, lens-retaining features 110A and 110B are situated somewhat above the midpoint of the height of rim 104. Lens-retaining features 110A and 110B extend radially inward by an amount in the range of about 1.5 to about 2.5 millimeters, and have a length in the range of about 5.0 to about 15 millimeters. In the illustrative embodiment, lens-retaining feature 110B is slightly longer than lens-retaining feature 110A, reflecting the slightly greater height of the lateral portion of rim 104, as compared to the medial portion of the rim.

In the illustrative embodiment, lens-retaining feature 112 is situated near the lowest portion of rim 104, which is towards the lateral portion of the rim.

Applicant's compression processes for creating regions of distinct material composition and fiber alignment are necessarily subject to certain geometric constraints. For example, as is known to those skilled in the art, a compression molding process is not well suited for forming an “undercut” feature, such as a channel, as is commonly used to retain lenses in isotropic frames. Rather, in accordance with the present teachings, the lens-retaining features are implemented as “opposing” features that function, in concert, to restrain and retain a lens, while not physically manifesting as a channel or groove. Thus, protrusions (i.e., the lens-retaining features 110A and 110B) on outward-facing surface 106 and protrusion (i.e., lens-retaining feature 112) on inward-facing surface 108 collectively retain the lens. As used herein, the term “lens-retaining feature” explicitly excludes a channel or groove formed in the rim surrounding a lens.

These opposing lens-retaining features are formed by opposite halves of a compression mold. For example, lens-retaining features 110A and 110B are formed by the cavity geometry of the female mold half, and lens-retaining feature 112 is formed by the plunger geometry of the male mold half. The parting line of the mold forms a diagonal between the inner and outer features, as it switches edges per the required draw to form the opposing undercuts.

FIG. 1C depicts, for portion 102 of illustrative eyewear frame 100 shown in FIGS. 1A and 1B, distinct material regions 114A and 114B, and distinct fiber alignment regions 116A and 116B with respective fiber alignments 118A and 118B therein.

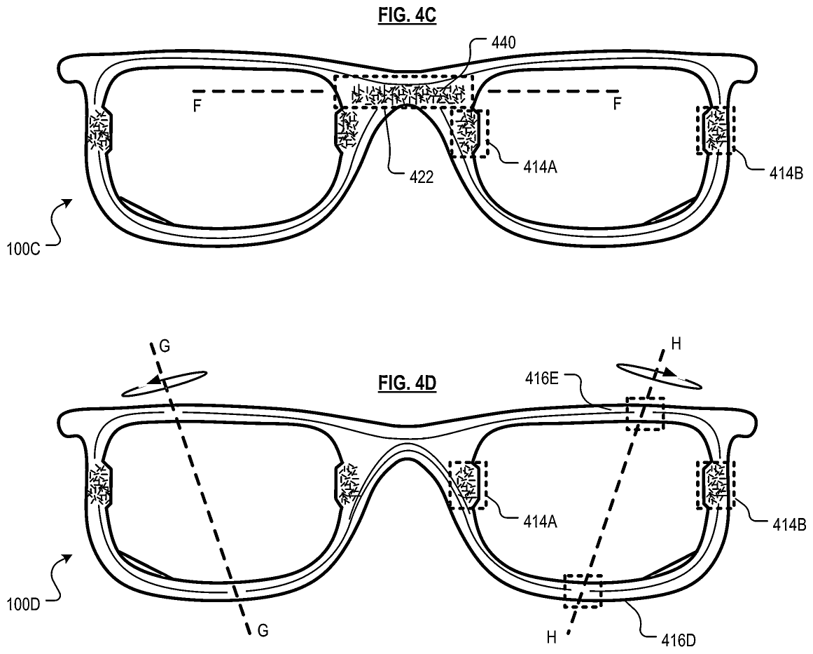

In the illustrative embodiment, distinct material regions 114A and 114B comprise a differential matrix polymer that is relatively compliant, such as TPU. In some embodiments, fibers are present in distinct material regions 114A and 114B. In some embodiments, the fibers are milled or chopped. In some other embodiments, somewhat longer fibers (but still relatively short fiber, being a few millimeters in length) are disposed within distinct material regions 114A and 114B. These fibers may be oriented substantially orthogonal to the length of lens-retaining features 110A and 110B. In some embodiments, one of distinct material regions 114A or 114B includes fiber and the other region does not. (See FIGS. 4A-4C for examples of the aforementioned and other alternative embodiments of fibers within distinct material regions 114A and 114B.)

In yet some further embodiments, one of the distinct material regions 114A or 114B is not present, such that bulk matrix polymer is present, whereas the one remaining distinct material region comprises a relatively more compliant material than the bulk matrix polymer. In such embodiments, because of the increased compliance of the single distinct material region, the eyewear frame can elastically deform enough to insert/remove a lens.

In contrast to lens-retaining features 110A and 110B and the associated material regions 114A and 114B, lens-retaining feature 112 and the immediate surrounds comprise a relatively less compliant material (than used in regions 114A and 114B), such as PC or nylon. Additionally, or alternatively, the fiber alignment associated with lens-retaining feature 112 renders it relatively less flexible than lens-retaining features 110A and 110B. Regarding fiber alignment, in some embodiments, fibers running around rim 104 extend into lens-retaining feature 112. In such embodiments, lens-retaining feature 112 is stiffer than it would be if the long fibers running along rim 104 did not extend therein, and it is therefore stiffer by virtue of such alignment than lens-retaining features 110A and 110B.

In some embodiments, fiber 118A within distinct fiber-alignment region 116A follow the curve of rim 104, but do not extend into distinct material regions 114A and 11B. Fibers 118B within distinct fiber-alignment region 116B follow the curve of lateral portion of rim 104, but extend straight toward the vertical centerline A-A toward the median portion of rim 104.

In some embodiments, polycarbonate is present as the bulk matrix polymer throughout distinct fiber-alignment region 116A and 116B.

FIG. 1D depicts the application of force to remove or insert a lens from eyewear 100 depicted in FIGS. 1A through 1C. By applying pressure in the direction indicated at F1 and F2, a fulcrum is created along axis B-B once an opposing pressure is applied in the direction indicated at F3 (and the portion of rim 104 opposite F3 is appropriately constrained). Rotational arrow M shows the resultant moment.

When subject to the applied forces, the compliant, distinct material regions 114A and 114B will flex and a resultant deflection of frame 100 will occur at F3. This deflection will free a lens from lens-retaining feature 112, thereby allowing it to be removed and a replacement subsequently inserted following a similar sequence. The arrangement of distinct material regions and distinct fiber-alignment regions in eyewear frame 100 provides very high hoop stiffness for keeping a lens in place, but low stiffness in torsion allowing the easy removal of lenses by twisting.

During high-volume manufacturing, the force application can be provided through fixtures and typical automation equipment for initial lens insertion into the frame. Once the user decides to swap lenses, they can do so by using their index fingers to provide fulcrum pressure and thumbs to push on the frame to flex the compliant zone.

Unlike isotropic frames, whose differential bending response is a function of variable geometry alone, eyewear frame 100 enables a differential bending response with minimal effect on industrial design. This specific application of force is unlikely to occur during normal use scenarios. Consequently, the lenses are retained during use of the eyewear, while enabling them to be readily reconfigured as desired. Furthermore, the simplicity of the force application enables users and manufacturers alike to efficiently configure lenses.

Thus, eyewear frame 100 provides user configurability of lenses via the presence of (i) distinct fiber-alignment regions 116A and 116B and (ii) distinct material regions 114A and 114B), in conjunction with lens-retaining features 110A, 110B, and 112.

FIGS. 4A through 4D depict eyewear frames 100A through 100D, each having different distinct material and fiber-alignment regions in accordance with the present teachings. The arrangement of distinct material regions and distinct fiber-alignment regions in eyewear frames 100A through 100C are additional examples of designs that provide very high hoop stiffness for keeping a lens in place, but low stiffness in torsion enabling easy removal of lenses by twisting.

FIG. 4A depicts eyewear frame 100A, wherein each of the left and right rims includes a variety of distinct material regions and distinct fiber-alignment regions.

The lateral lens-retaining feature 110B of each rim includes both distinct material region 414B and a distinct fiber-alignment region 418.

Distinct material region 414B (and 414A) of each lens comprise a relatively more compliant thermoplastic resin (differential matrix polymer) as compared to the relatively less compliant thermoplastic resin (bulk matrix polymer) present in other regions of frame 100A. Non-limiting examples of such relatively more compliant and relatively less compliant thermoplastic resins have been previously described. It is within the capabilities of those skilled in the art to select a differential matrix polymer and a bulk matrix polymer from these or other thermoplastics resins.

Distinct fiber-alignment region 418 within lens-retaining feature 414B is a plurality of coaligned short fibers 440. In the embodiment depicted in FIG. 4A, short fibers 440 have a “horizontal” alignment. It is notable that medial lens-retaining feature 110A includes chopped fiber 442, which has a random orientation (the fibers are not aligned).

Eyewear frame 100A also includes distinct fiber-alignment regions 416A and 416B, as are present in eyewear frame 100 as depicted in FIG. 1C. Furthermore, eyewear frame 100A includes distinct fiber-alignment regions 420, which are situated proximal to the vertical center line (not depicted), one such region 420 on each side thereof. Within distinct fiber-alignment regions 420, a plurality of short fibers 444 are oriented horizontally.

With forces applied as depicted in FIG. 1D (and the frame appropriately constrained), a fulcrum is created along axis D-D, and the compliant, distinct material regions 114A and 114B will flex and the frame will deflect. This deflection will free a lens from one of lens-retaining features 112 (depending upon at which rim the forces are applied) thereby enabling the lens to be removed and a replacement subsequently inserted following a similar sequence.

FIG. 4B depicts eyewear frame 100B, wherein each of the left and right rims includes a variety of distinct material regions and distinct fiber-alignment regions.

Lens-retaining features 110A and 110B of each rim includes respective distinct material regions 414A and 414B. The material regions of eyewear frame 100B are the same as those of eyewear frame 100A of FIG. 4A. However, in eyewear frame 100B, lateral lens-retaining feature 110B does not include a distinct fiber-alignment region. Rather, lens-retaining feature 110B of each rim comprises chopped fiber, which is not aligned. And lens-retaining feature 110A of each rim is neat thermoplastic resin; that is, fiber is not present.

Eyewear frame 100B has the same essentially the same distinct fiber alignment throughout most of the rim, with the exception of a difference in fiber alignment in the bridge region. Consequently, force is applied as for eyewear frame 100A, with the essentially the same result and a fulcrum created along axis E-E. Regions 414A and 414B of the appropriate rim will flex, and the frame deflects as a result, enabling a lens to be removed and subsequently replaced via a similar sequence.

FIG. 4C depicts eyewear frame 100C. Fiber alignment around each rim is similar to eyewear frames 100A and 100B. Eyewear frame 100C includes region 422 comprising chopped fiber 440, which is located between the rims at the nose bridge. Based on the distinct fiber alignment surrounding each rim, eyewear frame 100C will behavior similarly to eyewear frame 100A and 100B. Once again, with force being applied as for eyewear frames 100A and 100B, a fulcrum is created along axis F-F. Regions 414A and 414B of the appropriate rim will flex, and the frame deflects as a result, enabling a lens to be removed and subsequently replaced via a similar sequence.

FIG. 4D depicts eyewear frame 100D. Fiber alignment around each rim is different than eyewear frames 100A, 100B, and 100C. In particular, the fibers in distinct fiber-alignment regions 416D and 416E along the respective lower and upper portions of each rim are not continuous. To remove or insert a lens, force is applied to the vertical midpoint of the lateral edge of the rim, while stabilizing the nose bridge region. This creates a fulcrum (i.e., along axes G-G or H-H). The frame will deflect, enabling a lens to be removed and subsequently replaced via a similar sequence.

In some other embodiments, lens-retaining features are placed at the corners of the lens enabling easy lens insertion and removal via twisting of the frames. The lenses are held in place by the high hoop stiffness afforded by fibers oriented in the hoop direction around the lenses.

Although the features of eyewear frame 100 of FIGS. 1A through 1D, and FIGS. 4A through 4D could be manufactured via prior-art processes, such as injection molding, such features would either be subject to undesirable dislodging due to inadvertent deflection of the frame, or they will lock in place, preventing reconfigurability. An eyewear frame in accordance with the present teachings cannot be fabricated using entirely isotropic material (e.g., chopped fiber, etc.).

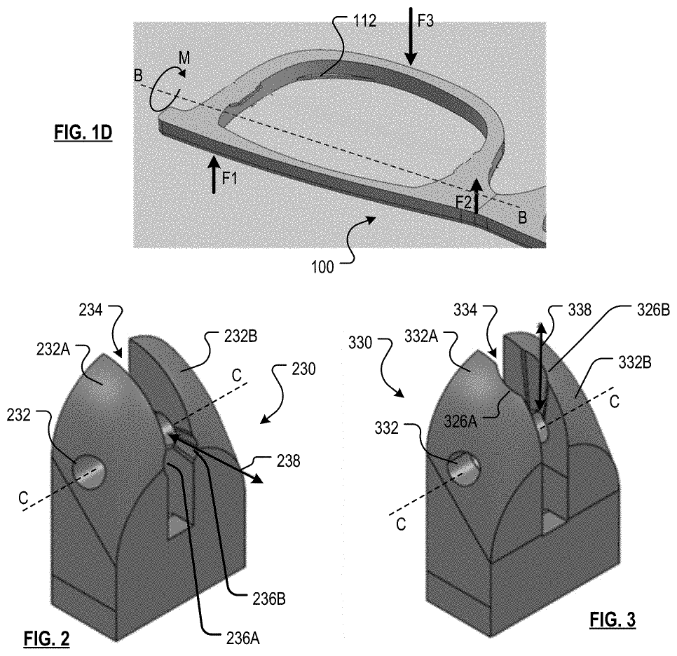

FIG. 2 depicts temple-retaining feature 230, which is an embodiment of a temple-retaining feature. Temple-retaining feature 230 is sited at location 120 on eyewear frame 100 as depicted in FIG. 1B (and omitted in FIG. 2 for clarity). As is conventional for eyewear, one temple-retaining feature is associated with each lens.

Temple-retaining feature 230 includes spaced-apart cantilevered arms 232A and 232B, with slot 234 therebetween. The slot is dimensioned and arranged to receive an end of a temple (not depicted). The opposing surfaces of cantilevered arms 232A and 232B include respective lead-in grooves 236A and 236B. These lead-in grooves accept a small feature, such as bump or other domed feature that protrudes from each side of one end of a temple. For example, in some embodiments, a ball bearing is positioned near the end of the temple, such that at least a portion of each hemisphere of the ball bearing extends from each side of the end of the temple.

To couple an appropriately configured temple to temple-retaining feature 230, the domed feature protruding from each side of the end of a temple is aligned with lead-in grooves 236A and 236B. The temple is slid forward into slot 234, and arms 232A and 232B deflect as the temple is advanced. Eventually, the domed feature snaps into place in through-holes 232. Once snapped in place, a pivot is created. Axis C-C of through-holes 232 is the axis of the pivot that folds the temples (not depicted). To remove the temple, a specifically directed force is applied to deflect the cantilevers (e.g. such as a force that will spread the cantilevers, etc.) thus freeing the domed feature from through-holes 232 as it displaces along the lead in channel. Movement of the temple into and out of slot 234 is indicated by bi-directional arrow 238.

FIG. 3 depicts temple-retaining feature 330, which is essentially the same as temple-restraining feature 230, with the exception of the orientation of the lead-in grooves 326A and 326B, and, concomitantly, the movement of a temple into and out of slot 334.

Cantilevered arms 232A and 232B of temple-retaining feature 230, and cantilevered arms 332A and 332B of temple-retaining feature 330 are necessarily compliant to enable a temple to be inserted. Consequently, in some embodiments, these cantilevered arms comprise a distinct material region including a differential matrix polymer that is more compliant, such as TPU, than the bulk matrix polymer used in other regions of eyewear frame 100. In some embodiments, the cantilevered arms include fibers that align with the length of the cantilevered arms. In some other embodiments, the cantilevered arms include non-aligned short or chopped. In some other embodiments, the cantilevered arms consist of neat differential matrix polymer.

It is to be understood that the disclosure describes a few embodiments and that many variations of the invention can easily be devised by those skilled in the art after reading this disclosure and that the scope of the present invention is to be determined by the following claims.

What is claimed:

1. An eyewear frame comprising:
a first rim and a second rim, each rim shaped to receive an eyewear lens, each rim having an outwardly facing surface and an inwardly facing surface, the first and second rims comprising a first thermoplastic resin;
a first lens-retaining feature depending from a medial side of the first and second rims and a second lens-retaining feature depending from a lateral side of the first and second rims, wherein:
(a) the first and second lens-retaining features are proximal to the outwardly facing surface of respective first and second rims,
(b) the first and second lens retaining features of respective first and second rims extend inwardly towards one another,
(c) the first and second lens-retaining features comprise a second thermoplastic resin,
(d) the second thermoplastic resin is relatively more compliant than the first thermoplastic resin; and
a third lens-retaining feature depending from the inwardly facing surface of the rim.

2. The eyewear frame of claim 1 comprising a first temple-retaining feature proximal to the lateral side of the first rim and a second temple-retaining feature proximal to the lateral side of the second rim, wherein the first and second temple-retaining features are dimensioned and arranged to receive respective first and second temples.

3. The eyewear frame of claim 2 wherein each of the first and second temple-retaining features have two cantilevered arms that are spaced apart from one another, wherein a gap is defined therebetween.

4. The eyewear frame of claim 3 wherein the two cantilevered arms of the respective first and second temple features include through-holes, the through-holes of the respective first and second temple features defining a pivot axis for respective first and second temples.

5. The eyewear frame of claim 4 wherein each cantilevered arm has a lead-in groove that extends from a mouth of the gap to the through-hole in the respective cantilevered arm.

6. The eyewear frame of claim 5 wherein a first end of each of respective first and second temples include a domed feature extending from opposite sides thereof, wherein the domed feature is sized to be received by the through-holes in respective first and second temple features.

7. The eyewear frame of claim 6 wherein the first and second cantilevered arms of the respective first and second temple features are sufficiently compliant to enable the gap to enlarge for insertion or removal of respective first and second temples.

8. The eyewear frame of claim 7 wherein the first and second cantilevered arms of respective first and second temple features comprises the second thermoplastic.

9. The eyewear frame of claim 7 wherein the first and second cantilevered arms of respective first and second temple features each comprise a plurality of fibers that align with a length of each of the first and second cantilevered arms.

10. The eyewear frame of claim 1 wherein the first lens retaining feature comprises non-aligned fiber.

11. The eyewear frame of claim 10 wherein the second lens retaining feature comprises non-aligned fiber.

12. The eyewear frame of claim 10 wherein within each of the first and second rims, below the first and second lens-retaining features, respective first and second pluralities of fibers align with a shape of the rim.

13. The eyewear frame of claim 1 wherein the eyewear frame is symmetric about a vertical axis disposed between the first and second rims, and wherein the first and second rims each comprise fibers, and wherein no fibers cross the vertical axis of symmetry.

14. The eyewear frame of claim 1 further comprising a plurality of fibers, wherein fibers disposed in a region between the two rims are oriented substantially horizontally.

15. A method for making an eyewear frame, the method comprising:
providing an assemblage of preforms, the assemblage including a plurality of fiber-bundle-based preforms, wherein the fiber-bundle-based preforms are arranged into a shape of the eyewear frame, the shape comprising:
(a) a first rim and a second rim, each rim having a closed geometry and configured to receive an eyewear lens,
(b) a first lens-retaining feature depending from a medial side of the first and second rims and a second lens-retaining feature depending from a lateral side of the first and second rims, the first and second lens-retaining feature depending from a first surface of each rim,
(c) a third lens-retaining feature sited proximal to the lateral side of the first and second rims and depending from a second surface of each rim, and
wherein the assemblage includes at least one of: one or more distinct material regions and one or more distinct fiber alignment regions, wherein:
(i) each distinct material region comprises a first thermoplastic polymer that is relatively more compliant than a second thermoplastic resin disposed in regions of the assemblage other the one or more distinct material regions; and
(ii) each distinct fiber-alignment region is a region in which a fiber orientation differs from other regions within the assemblage; and
compression molding the assemblage to provide an eyewear frame.

16. The method of claim 15 wherein the first lens-retaining feature comprises a first distinct material region.

17. The method of claim 16 wherein the second lens-retaining feature comprises a second distinct material region.

18. The method of claim 15 wherein an upper portion of each of the first and second rims comprise first distinct fiber alignment regions and a lower portion of each of the first and second rims comprise second distinct fiber alignment regions.
